(19) United States
(12) Patent Application Publication
(10) Pub. No.: US 2014/0022167 A1
(43) Pub. Date: Jan. 23, 2014

(54) PROJECTION APPARATUS AND PROJECTION METHOD

(71) Applicants: Aritaka HAGIWARA, Kanagawa (JP); Hidekuni Annaka, Saitama (JP); Motoyuki Katsumata, Kanagawa (JP)

(72) Inventors: Aritaka HAGIWARA, Kanagawa (JP); Hidekuni Annaka, Saitama (JP); Motoyuki Katsumata, Kanagawa (JP)

(21) Appl. No.: 13/935,702

(22) Filed: Jul. 5, 2013

(30) Foreign Application Priority Data
Jul. 23, 2012 (JP) 2012-163106

(51) Int. Cl. G06F 3/03

(52) U.S. Cl. CPC G06F 3/03
USPC 345/157

(57) ABSTRACT

A projection apparatus includes: a position detecting unit that detects a position of a pointer indicated by a pointing device on a projection surface; a calculating unit that calculates a characteristic value that represents characteristics of move of the pointer from positions detected by the position detecting unit in a predetermined period; a determining unit that determines whether or not the calculated characteristic value is equal to or greater than a predetermined threshold value; and an image generating unit that, when the characteristic value is determined to be smaller than the predetermined threshold value, generates an image to be projected by enlarging a region containing and surrounding the pointer.

### CROSS-REFERENCE TO RELATED APPLICATIONS

The present application claims priority to and incorporates by reference the entire contents of Japanese Patent Application No. 2012-163106 filed in Japan on Jul. 23, 2012.

### BACKGROUND OF THE INVENTION

1. Field of the Invention

The present invention relates to a projection apparatus and a projection method.

2. Description of the Related Art

Projection apparatuses that project data supplied from a PC or the like onto a screen, a wall, or the like are conventionally known. Such a projection apparatus typically allows a user to perform operation, such as moving to a next page or sliding, on projected data using a pointing device or the like, and/or to project a text character, a graphic object, or the like along a path drawn with a pointer of a pointing device.

Japanese Patent Application Laid-open No. 2007-26515 discloses a technique for enlarging a part of an image displayed on a projection screen in accordance with an operation performed by a user. In Japanese Patent Application Laid-open No. 2007-26515, a projector includes a zoom key for use in instructing the projector to zoom in, and is configured to enlarge an image by operating the zoom key while specifying a location by indicating with a cursor.

However, in the conventional method for zooming in the projection screen, a desired position may not be appropriately enlarged in a situation where an attempt of zooming in is made by operating the screen using a pointing device, because the location specified by the cursor fluctuates due to motion of the pointing device caused by manipulation or the like.

In view of the above circumstance, there is a need for a projection apparatus that allows enlarging a desired region on a projection screen by a simple operation.

### SUMMARY OF THE INVENTION

It is an object of the present invention to at least partially solve the problem in the conventional technology.

A projection apparatus includes: a position detecting unit that detects a position of a pointer indicated by a pointing device on a projection surface; a calculating unit that calculates a characteristic value that represents characteristics of move of the pointer from positions detected by the position detecting unit in a predetermined period; a determining unit that determines whether or not the calculated characteristic value is equal to or greater than a predetermined threshold value; and an image generating unit that, when the characteristic value is determined to be smaller than the predetermined threshold value, generates an image to be projected by enlarging a region containing and surrounding the pointer.

A projection method includes: detecting positions of a pointer indicated by a pointing device on a projection surface; calculating a characteristic value that represents characteristics of move of the pointer from positions detected at the detecting in a predetermined period; determining whether or not the calculated characteristic value is equal to or greater than a predetermined threshold value; and generating an image to be projected by enlarging a region containing and surrounding the pointer when the characteristic value is determined to be smaller than the predetermined threshold value.

A projection system includes: a position detecting unit that detects a position of a pointer indicated by a pointing device on a projection surface; a calculating unit that calculates a characteristic value that represents characteristics of move of the pointer from positions detected by the position detecting unit in a predetermined period; a determining unit that determines whether or not the calculated characteristic value is equal to or greater than a predetermined threshold value; and an image generating unit that, when the characteristic value is determined to be smaller than the predetermined threshold value, generates an image to be projected by enlarging a region containing and surrounding the pointer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a functional configuration of a projection apparatus according to a first embodiment;

FIG. 2A is a diagram illustrating one example of a projection screen according to the first embodiment;

FIG. 2B is another diagram illustrating the one example of the projection screen according to the first embodiment;

FIG. 3 is a sequence diagram of a procedure for enlarging projection image data according to the first embodiment;

FIG. 4 is a flow diagram of a procedure for determining whether or not to enlarge projection image data according to the first embodiment;

FIG. 5A is a diagram illustrating one example of the projection screen according to the first embodiment;

FIG. 5B is another diagram illustrating the one example of the projection screen according to the first embodiment;

FIG. 6A is a diagram illustrating one example of the projection screen according to the first embodiment;

FIG. 6B is another diagram illustrating the one example of the projection screen according to the first embodiment; and

FIG. 7 is a flow diagram of a procedure for determining whether or not to restore the projection image data to a not-enlarged state according to the first embodiment.

### DETAILED DESCRIPTION OF THE PREFERRED EMBODIMENTS

An embodiment of a projection apparatus according to the present invention is described in detail below with reference to the accompanying drawings.

### First Embodiment

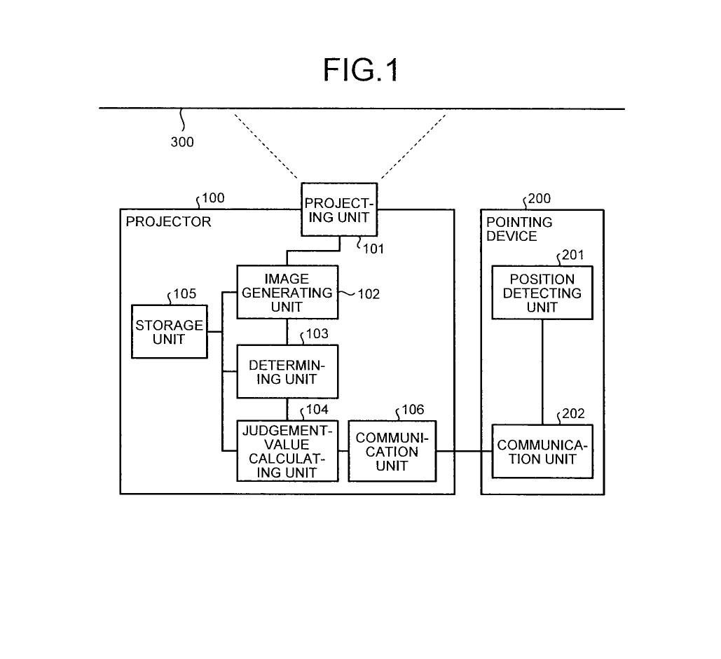

FIG. 1 is a block diagram illustrating a functional configuration of a projection apparatus according to a first embodiment. A projector 100, which is an projection apparatus, includes a projecting unit 101, an image generating unit 102, a determining unit 103, a judgement-value calculating unit 104, a storage unit 105, and a communication unit 106. The projecting unit 101 optically projects image data generated by the image generating unit 102 onto a screen 300. The image generating unit 102 generates image data to be projected (hereinafter, “projection image data”) from data input from a terminal, such a PC, or a drawing specified using a pointing device 200, which will be described later. The generated image data is stored in the storage unit 105. The communication unit 106 transmits and receives data to and from the pointing device 200. The communication unit 106 carries out communications with the pointing device 200 in accordance with a wireless communication standard, e.g., the Wi-Fi (registered trademark) or the Blootooth (registered trademark).

The judgement-value calculating unit 104 calculates a characteristic value of move when the pointing device 200 is manipulated. The characteristic value is used to determine whether or not to enlarge projection image data. This will be described in detail later. The determining unit 103 determines whether or not to enlarge the projection image data depending on whether or not the characteristic value is equal to or greater than a predetermined threshold value. The characteristic value may be stored in the storage unit 105.

The pointing device 200 includes a position detecting unit 201 and a communication unit 202. The pointing device 200 can be used to draw a text character, a graphic object, or the like along a path indicated by the pointer. The position detecting unit 201 acquires position coordinates of a position indicated by the pointer of the pointing device 200 on the screen 300. The position detecting unit 201 is not necessarily included in the pointing device 200. Alternatively, the projector 100 may be configured such that the projector 100 performs position detection based on the acquired image data in which a position is indicated by the pointer using the pointing device 200. The communication unit 202 transmits the detected position coordinates to the projector 100. The communication unit 202 transmits position coordinates to the projector 100 each time position coordinates are detected.

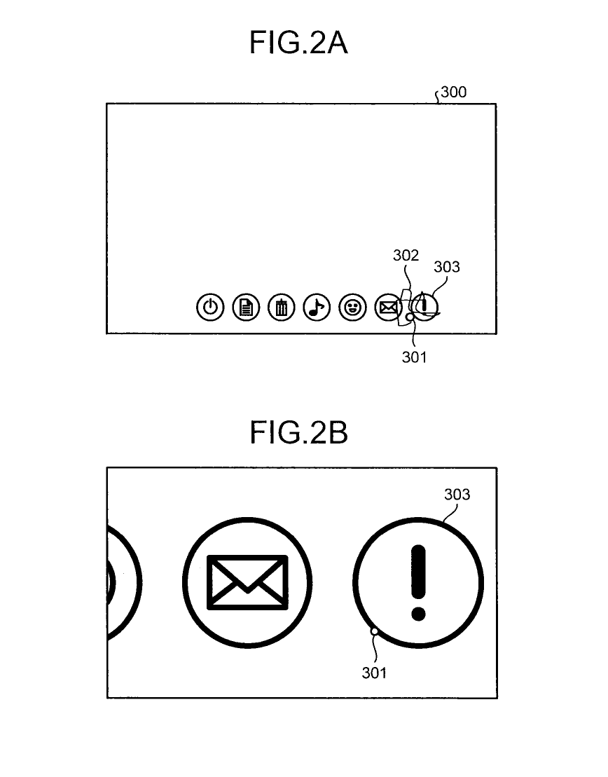

FIG. 2A is a diagram illustrating an example of a screen layout of the screen 300. As illustrated in FIG. 2A, a pointer 301 and an operation icon 303 are displayed on the screen 300. A path 302 indicates a path along which the pointer 301 has moved. In the projector 100 of the first embodiment, projection image data is enlarged and projected as illustrated in FIG. 2B when characteristics of move of the pointer over a predetermined period correspond to predetermined characteristics. In other words, zooming in is automatically performed without requiring a special operation when it is determined that enlarging projection image data to display a detail is preferable for a user based on motion of the pointing device 200.

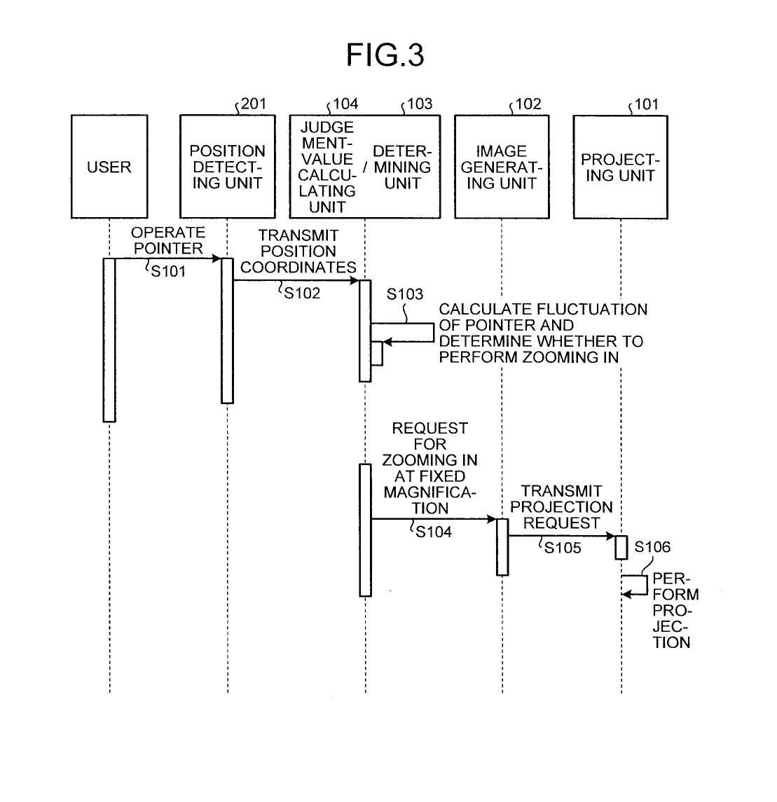

A procedure for enlarging projection image data is described below with reference to FIG. 3. As illustrated in FIG. 3, when a user operates the pointing device 200 to move the pointer (Step S101), the position detecting unit 201 detects coordinates of the position indicated by the pointer and transmits the position coordinates to the projector 100 (Step S102). Subsequently, the judgement-value calculating unit 104 calculates a characteristic value indicating characteristics of move of the pointing device 200 in the predetermined period using the received position coordinates. The determining unit 103 determines whether or not to perform zooming in depending on whether or not fluctuation of the pointer is within a predetermined range based on the characteristic value (Step S103).

When a result of the determination is that zooming in is to be performed, the determining unit 103 specifies magnification and requests the image generating unit 102 to enlarge an image to be projected (Step S104). The image generating unit 102 performs processing for enlarging the image to be projected at the specified magnification, and transmits a projection request to the projecting unit 101 (Step S105). The projecting unit 101 projects enlarged projection image data (Step S106).

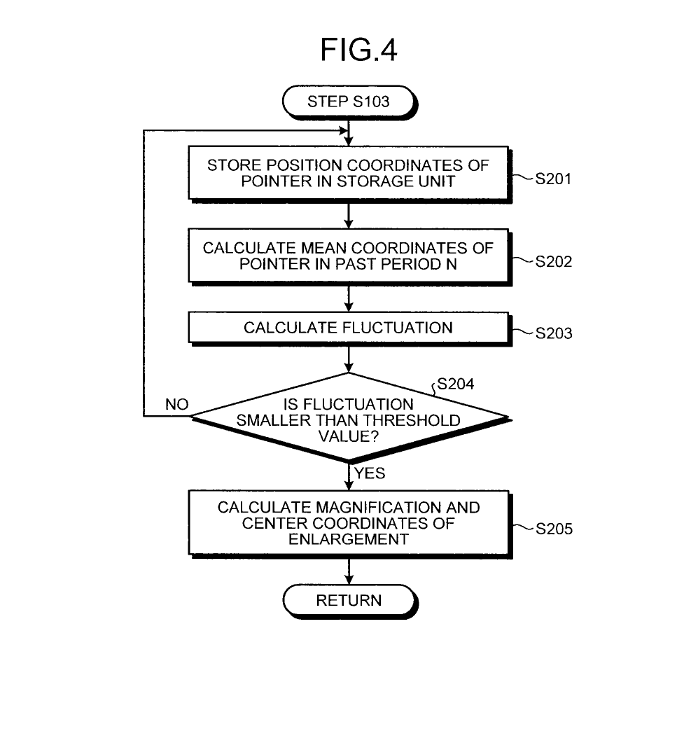

FIG. 4 illustrates a detail of processing to be performed in Step S103 for determining whether to perform zooming in. As illustrated in FIG. 4, the judgement-value calculating unit 104 stores coordinates of a position indicated by the pointer in the storage unit 105 each time position coordinates are received (Step S201). Subsequently, the judgement-value calculating unit 104 calculates mean coordinates of the pointer in a predetermined past period N (Step S202). The mean coordinates are mean values of all the position coordinates acquired during the period N. The mean coordinates can be calculated using Equation (1) below, for example. Equation (1) calculates mean coordinates x on an assumption that the predetermined period N is one second and the position coordinates of the pointer are acquired n times per second.

$$\overline{x} = \frac{1}{n} {\sum }_{i = 1}^{n} {x}_{i} \qquad ( 1 )$$

Subsequently, the judgement-value calculating unit 104 calculates fluctuation of the coordinates of the position indicated by the pointer (Step S203). The fluctuation is variance of the position coordinates of the pointer and an example of the characteristic value described above. As the fluctuation, variance σ² is calculated using Equation (2) below, for example.

$${σ}^{2} = \frac{1}{n} {\sum }_{i = 1}^{n} {( {x}_{i} - \overline{x} )}^{2} \qquad ( 2 )$$

The determining unit 103 determines whether or not the calculated fluctuation is smaller than a threshold value (Step S204). It is highly possible that it is intended to specify a certain position by the pointer in the predetermined period N when the fluctuation is smaller than the threshold value. Accordingly, in this case, a region containing and surrounding the position indicated by the pointer is enlarged. More specifically, when it is determined the calculated fluctuation is smaller than the threshold value (Yes in Step S204), the judgement-value calculating unit 104 calculates magnification and center coordinates of the enlargement (Step S205), and then returns to Step S104. The magnification may be fixed magnification stored in the storage unit 105 in advance as described above or, alternatively, may be calculated from motion of the pointer each time. A method for calculating the magnification will be described later. The mean coordinates described above may be used as the center coordinates. Alternatively, position coordinates acquired most recently, or, in other words, position coordinates of a position currently indicated by the pointer may be used as the center coordinates. When it is determined that the calculated fluctuation is equal to or greater than the threshold value (No in Step S204), the procedure from Step S201 is repeated.

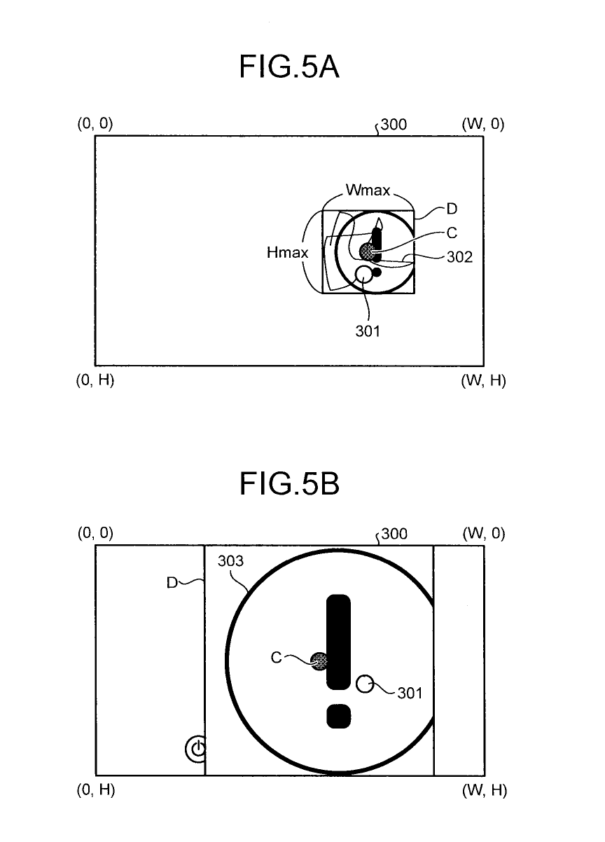

The method for calculating the magnification is described below with reference to FIGS. 5A and 5B. FIG. 5A is a diagram illustrating a projection screen in a state where zooming in is not performed yet. The magnification is calculated using Wmax, which is a horizontal distance moved by the pointer 301, and Hmax, which is a vertical distance moved by the pointer 301, illustrated in FIG. 5A. Reference symbol D in FIGS. 5A and 5B denotes a rectangular region circumscribing an outer perimeter of a path of the pointer 301. C denotes center coordinates of the rectangle.

In the first embodiment, as illustrated in FIG. 5B, magnification that causes the region D containing and surrounding the pointer 301 (hereinafter, referred to as “the approximate region D” in some cases) to be maximally enlarged to match the height or width of the projection screen on the screen 300 is calculated as the enlarging magnification. More specifically, the magnification is set to a smaller one of W/Wmax and H/Hmax. In the embodiment, zooming in is performed so as to cause the region D to match the height of the projection screen, and the magnification is set to H/Hmax. In the embodiment, the starting point for zooming in is the center coordinates C of the approximate region D.

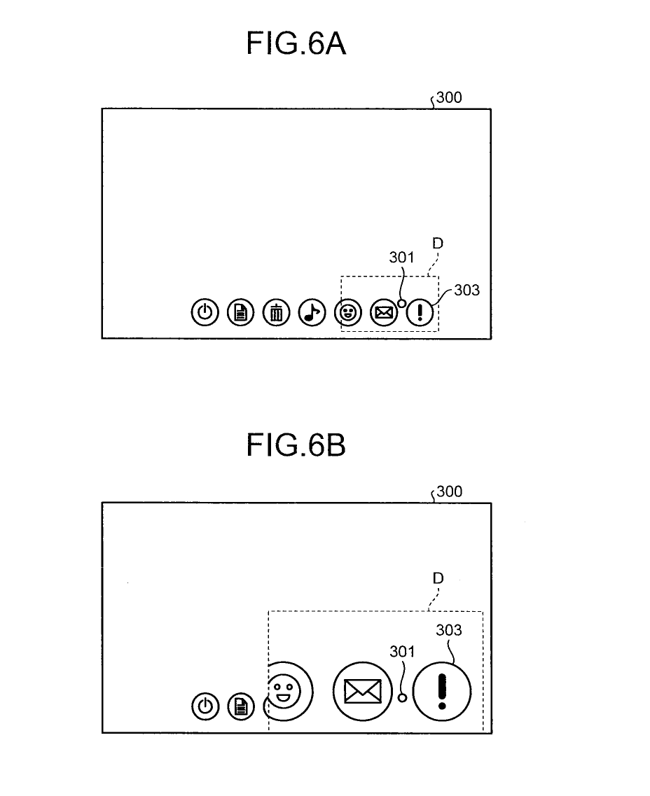

Another method for enlargement is described below with reference to FIGS. 6A and 6B. In the example illustrated in FIG. 6A, zooming in is performed using the current position of the pointer 301, rather than the center coordinates of the approximate region D, as the reference so that the coordinates of the position indicated by the pointer 301 remain the same before and after the zooming in. More specifically, as illustrated in FIG. 6B, zooming in is performed to such an extent that the coordinates indicated by the pointer 301 is not changed rather than in such a manner that the region D is enlarged to fully fill the projection screen on the screen 300.

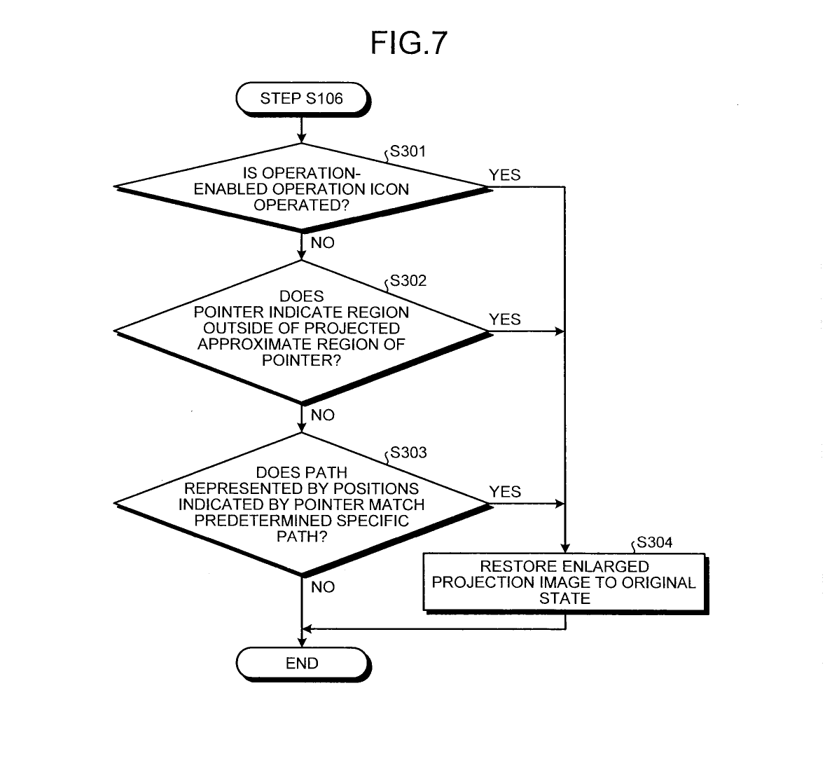

An example of a procedure to be performed after the enlarged projection image data is projected (more specifically, steps that follow Step S106 illustrated in FIG. 3) are described below with reference to FIG. 7. As illustrated in FIG. 7, processing for restoring the enlarged image data to its original size is performed by making determination of Step S301 through Step S303 below after the image data is projected. First, whether or not an operation-enabled operation icon is operated using the pointing device 200 is determined (Step S301).

When it is determined that the operation-enabled operation icon has been operated (Yes in Step S301), this means that the operation icon displayed while being enlarged has been operated, and therefore it is determined that continuing zooming in is unnecessary any more. Accordingly, the image generating unit 102 restores the enlarged projection image data to its original state (Step S304), and the procedure ends. On the other hand, when the operation-enabled operation icon is not operated (No in Step S301), whether or not the pointer 301 indicates a region outside of the projected approximate region of the pointer 301 or, in other words, the pointer 301 indicates a not-enlarged region, is determined (Step S302).

When it is determined that the pointer 301 indicates the region outside of the projected approximate region of the pointer 301 (Yes in Step S302), the image generating unit 102 restores the enlarged projection image data to its original state (Step S304), and the procedure ends. On the other hand, when it is determined that the pointer 301 does not indicate the region outside of the projected approximate region of the pointer 301 (No in Step S302), whether or not a path represented by positions indicated by the pointer 301 matches a predetermined specific path is determined (Step S303). The specific path corresponds to a pattern of motion determined in advance to restore the enlarged projection image data to its original image size. For instance, a simple motion, such as a motion of writing an x letter or a circle, is stored in advance. When the motion of the pointer 301 is detected, the image data is restored from the enlarged state. When it is determined that the path of the pointer 301 matches the predetermined specific path (Yes in Step S303), the image generating unit 102 restores the enlarged projection image data to its original state (Step S304), and the procedure ends. On the other hand, when it is determined that the path of the pointer 301 does not match the predetermined specific path (No in Step S303), the procedure ends without any additional process.

The projection apparatus according to the embodiment enlarges an approximate region of a position specified by a user by indicating the position with the pointer 301 over the predetermined period, without requiring the user to operate some operation button. Accordingly, the projection apparatus allows the user to enlarge desired projection image data easily by intuitive operation.

By employing a configuration, in which the magnification can be changed depending on a range where the pointer 301 is moved, a user can obtain desired magnification by moving the pointing device 200 in a manner to specify the region that the user wants to zoom in.

When an operation for allowing restoring an enlarged screen to its original size is set in advance, it becomes possible to restore the screen immediately when enlarging is not required. This leads to enhancement in convenience.

In the projection apparatus described above, the approximate region to be enlarged of the pointer 301 is the rectangle with width or height that is the same as a maximum width or a maximum height of the range of motion of the pointer 301 in the predetermined period. Alternatively, a configuration, in which a region of a preset size is enlarged, can be employed. In the projection apparatus described above, variance is used as the characteristic value of motion of the pointer 301. Alternatively, for instance, whether or not to perform zooming in may be determined depending on whether or not a horizontal distance or a vertical distance moved by the pointer 301 in the predetermined period is smaller than a predetermined threshold value.

In the projection apparatus described above, all functions are provided in the projector. Alternatively, a configuration in which, for instance, processing described above is performed by a general-purpose information processing apparatus, such as a PC, and the projector and the information processing apparatus that are connected to each other are used can be employed.

According to the embodiment, it becomes possible to enlarge a desired region on a projection screen by a simple operation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projection apparatus comprising:
a position detecting unit that detects a position of a pointer indicated by a pointing device on a projection surface;
a calculating unit that calculates a characteristic value that represents characteristics of move of the pointer from positions detected by the position detecting unit in a predetermined period;
a determining unit that determines whether or not the calculated characteristic value is equal to or greater than a predetermined threshold value; and
an image generating unit that, when the characteristic value is determined to be smaller than the predetermined threshold value, generates an image to be projected by enlarging a region containing and surrounding the pointer.

2. The projection apparatus according to claim 1, wherein the image generating unit generates the image to be projected by enlarging the region containing and surrounding the pointer at predetermined fixed magnification.

3. The projection apparatus according to claim 1, further comprising
a magnification calculating unit that calculates a maximum vertical distance moved by the pointer in the predetermined period and a maximum horizontal distance moved by the pointer in the predetermined period, and calculates, as the magnification, a smaller one of a value obtained by dividing a vertical length of the projection surface by the maximum vertical distance moved by the pointer and a value obtained by dividing a horizontal length of the projection surface by the maximum horizontal distance moved by the pointer, wherein
the image generating unit generates the image to be projected by enlarging the region containing and surrounding the pointer at the calculated magnification.

4. The projection apparatus according to claim 1, wherein the image generating unit uses, as the region containing and surrounding the pointer, a rectangular region having a center at mean coordinates of positions of the pointer detected in the predetermined period, a vertical length that is same as a maximum vertical distance moved by the pointer in the predetermined period and a horizontal length that is same as a maximum horizontal distance moved by the pointer in the predetermined period, and enlarges the image to be projected using the center as a reference.

5. The projection apparatus according to claim 1, wherein the image generating unit uses, as the region containing and surrounding the pointer, a rectangular region having a center at a position of the pointer when enlarging, a vertical length that is same as a maximum vertical distance moved by the pointer in the predetermined period and a horizontal length that is same as a maximum horizontal distance moved by the pointer in the predetermined period, and enlarges the image to be projected using the center as a reference.

6. The projection apparatus according to claim 1, wherein the image generating unit enlarges the image to be projected when coordinates of positions of the pointer detected in the predetermined period includes coordinates that coincide with a location of an operation icon on the projection surface.

7. The projection apparatus according to claim 1, wherein when the image to be projected that is enlarged is projected and an operation icon projected on the projection surface is operated by the pointer, the image generating unit restores the image to be projected to a not-yet-enlarged state.

8. The projection apparatus according to claim 1, wherein when the image to be projected that is enlarged is projected and it is detected the pointer indicates a region outside of the region containing and surrounding the pointer, the image generating unit restores the image to be projected to a not-yet-enlarged state.

9. The projection apparatus according to claim 1, wherein when a path represented by positions indicated by the pointer match a predetermined specific path, the image generating unit restores the image to be projected to a not-yet-enlarged state.

10. A projection method comprising:
detecting positions of a pointer indicated by a pointing device on a projection surface;
calculating a characteristic value that represents characteristics of move of the pointer from positions detected at the detecting in a predetermined period;
determining whether or not the calculated characteristic value is equal to or greater than a predetermined threshold value; and
generating an image to be projected by enlarging a region containing and surrounding the pointer when the characteristic value is determined to be smaller than the predetermined threshold value.

11. The projection method according to claim 10, wherein at the generating, the image to be projected is generated by enlarging the region containing and surrounding the pointer at predetermined fixed magnification.

12. The projection method according to claim 10, further comprising calculating a maximum vertical distance moved by the pointer in the predetermined period and a maximum horizontal distance moved by the pointer in the predetermined period, and calculating, as the magnification, a smaller one of a value obtained by dividing a vertical length of the projection surface by the maximum vertical distance moved by the pointer and a value obtained by dividing a horizontal length of the projection surface by the maximum horizontal distance moved by the pointer, wherein
at the generating, the image to be projected is generated by enlarging the region containing and surrounding the pointer at the calculated magnification.

13. The projection method according to claim 10, wherein at the generating, a rectangular region is used as the region containing and surrounding the pointer, the rectangular region having a center at mean coordinates of positions of the pointer detected in the predetermined period, a vertical length that is same as a maximum vertical distance moved by the pointer in the predetermined period and a horizontal length that is same as a maximum horizontal distance moved by the pointer in the predetermined period, and the image to be projected is enlarged using the center as a reference.

14. The projection method according to claim 10, wherein at the generating, a rectangular region is used as the region containing and surrounding the pointer, the rectangular region having a center at a position of the pointer when enlarging, a vertical length that is same as a maximum vertical distance moved by the pointer in the predetermined period and a horizontal length that is same as a maximum horizontal distance moved by the pointer in the predetermined period, and the image to be projected is enlarged using the center as a reference.

15. The projection method according to claim 10, wherein at the generating, the image to be projected is enlarged when coordinates of positions of the pointer detected in the predetermined period includes coordinates that coincide with a location of an operation icon on the projection surface.

16. The projection method according to claim 10, further comprising restoring the image to be projected to a not-yet-enlarged state when the image to be projected that is enlarged is projected and an operation icon projected on the projection surface is operated by the pointer.

17. The projection method according to claim 10, further comprising restoring the image to be projected to a not-yet-enlarged state when the image to be projected that is enlarged is projected and it is detected the pointer indicates a region outside of the region containing and surrounding the pointer.

18. The projection method according to claim 10, further comprising restoring the image to be projected to a not-yet-enlarged state when a path represented by positions indicated by the pointer match a predetermined specific path.

19. A projection system comprising:
a position detecting unit that detects a position of a pointer indicated by a pointing device on a projection surface;
a calculating unit that calculates a characteristic value that represents characteristics of move of the pointer from positions detected by the position detecting unit in a predetermined period;
a determining unit that determines whether or not the calculated characteristic value is equal to or greater than a predetermined threshold value; and
an image generating unit that, when the characteristic value is determined to be smaller than the predetermined threshold value, generates an image to be projected by enlarging a region containing and surrounding the pointer.
